(19) United States
(12) Patent Application Publication
(10) Pub. No.: US 2003/0217157 A1
(43) Pub. Date: Nov. 20, 2003

(54) Method and apparatus to reduce wireless data transfer delay

(76) Inventors: Sharon W. Tung, Arlington Heights, IL (US); Jay Jayapalan, Buffalo Grove, IL (US); John M. Harris, Chicago, IL (US)

Correspondence Address: MOTOROLA, INC., 1303 EAST ALGONQUIN ROAD, IL01/3RD, SCHAUMBURG, IL, 60196

(21) Appl. No.: 10/108,783

(22) Filed: Mar. 28, 2002

(51) Int. Cl. G06F 15/16

(52) U.S. Cl. 709/228; 709/234

(57) ABSTRACT

To address the need for reducing the wireless data transfer delay without reducing channel utilization, an embodiment of this invention provides for a wireless unit (101), transitioning from a dormant to an active state, to transmit data, such as a data query, at the time of call origination. The Wireless Network delay and the Data Network delay, ordinarily experienced back-to-back, are instead experienced concurrently. The difference in delay experienced between active versus dormant users is thus nearly eliminated. This will motivate network operators to decrease their inactivity timers, and is thereby likely to improve their channel utilization and reduce the cost of packet data services.

### CROSS-REFERENCE TO RELATED APPLICATION

This application is related to a co-pending application entitled “METHOD AND APPARATUS FOR WIRELESS DATA TRANSFER WITH REDUCED DELAY,” filed on even date herewith, assigned to the assignee of the instant application, and hereby incorporated by reference.

### FILED OF THE INVENTION

The present invention relates generally to communication systems and, in particular, to wireless data transfer.

### BACKGROUND OF THE INVENTION

In existing wireless communication systems, the “cost per bit” for packet data services can be relatively high. This is due in part to low channel utilization. Presently, when a dormant wireless user queries a packet network, the response time experienced by that user includes (1) the time it takes for the Wireless Network to establish the required wireless traffic channels, and (2) the time it takes the Data Network (Intranet or the Internet) to respond with the requested content. Wireless traffic channels need to be established because the user's mobile has gone dormant due to inactivity.

To improve the user's perceived packet data response time, system operators increase the inactivity timers in their systems to allow users to remain active longer. Since the mobile unit does not need to reestablish traffic channels while active, the user only experiences the delay caused by the Data Network and not the Wireless Network when querying. However, this improved response time comes at the expense of channel utilization. A traffic channel remains assigned to a particular mobile until its inactivity timer expires. Thus, with longer inactivity timers, channels will be held without being utilized for a longer period of time. This situation is contributing to the present higher “cost per bit” for packet data services. Therefore, a need exists for an apparatus and method to reduce the wireless data transfer delay without reducing channel utilization.

### BRIEF DESCRIPTION OF THE DRAWINGS

FIG. 1 is a block diagram depiction of a communication system in accordance with a first embodiment of the present invention.

FIG. 2 is the first of four system messaging diagrams in accordance with a first embodiment of the present invention.

FIG. 3 is the second of four system messaging diagrams in accordance with a first embodiment of the present invention.

FIG. 4 is the third of four system messaging diagrams in accordance with a first embodiment of the present invention.

FIG. 5 is the fourth of four system messaging diagrams in accordance with a first embodiment of the present invention.

FIG. 6 is a logic flow diagram of step s execute d by a wireless unit in accordance with a first embodiment of the present invention.

FIG. 7 is a logic flow diagram of steps executed by a radio access network in accordance with a first embodiment of the present invention.

### DETAILED DESCRIPTION OF THE EMBODIMENTS

To address the need for reducing the wireless data transfer delay without reducing channel utilization, an embodiment of this invention provides for a wireless unit, transitioning from a dormant to an active state, to transmit data, such as a data query, at the time of call origination. The Wireless Network delay and the Data Network delay, ordinarily experienced back-to-back, are instead experienced concurrently. The difference in delay experienced between active versus dormant users is thus nearly eliminated. This will motivate network operators to decrease their inactivity timers, and is thereby likely to improve their channel utilization and reduce the cost of packet data services.

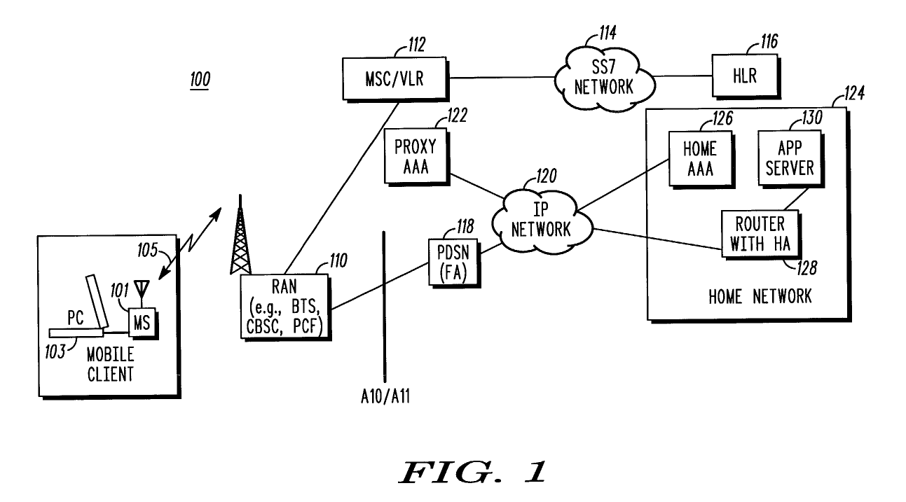

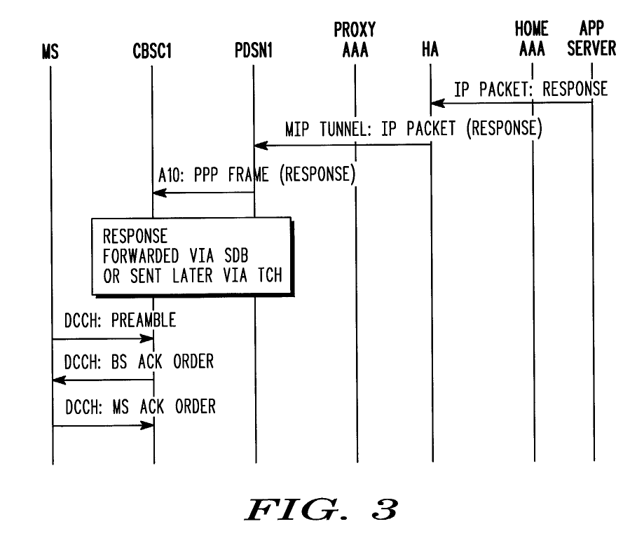

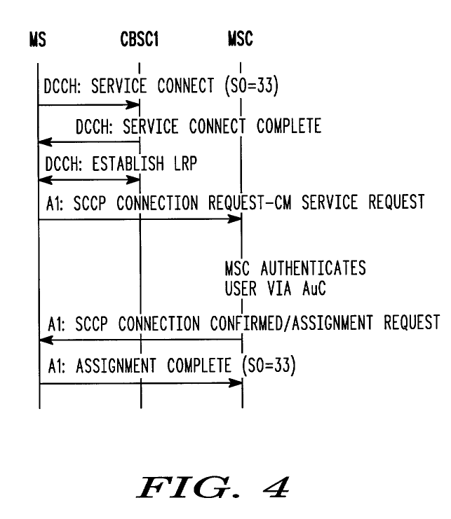

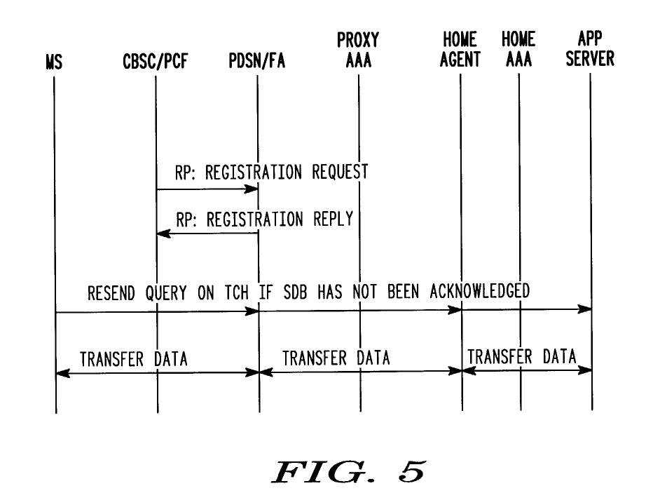

The present invention can be more fully understood with reference to FIGS. 1-7. FIG. 1 is a block diagram depiction of a communication system 100 in accordance with a first embodiment of the present invention. Communication system 100 is a well-known Code Division Multiple Access (CDMA) system, specifically a CDMA-1X system, which is based on the Telecommunications Industry Association/Electronic Industries Association (TIA/EIA) standard IS-2000 Release A (CDMA2000), suitably modified to implement the present invention. Alternative embodiments of the present invention may be implemented in communication systems that employ other technologies such as those based on the UMTS standards from 3GPP.

The first embodiment of the present invention includes radio access network (RAN) 110 and wireless units, such as mobile station (MS) 101, perhaps connected to personal computer 103. However, the present invention is not limited to wireless units that are mobile. For example, a wireless unit may comprise a desktop computer wirelessly connected to the radio access network.

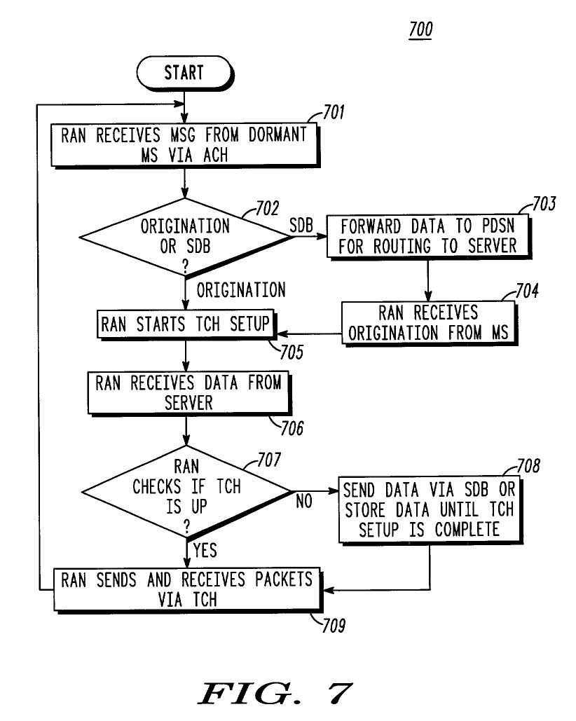

Those skilled in the art will recognize that FIG. 1 does not depict all of the network equipment necessary for system 100 to operate but only those devices particularly relevant to the description of this first embodiment of the present invention. For example, RAN 110 comprises well-known entities such as a base transceiver station (BTS), a centralized base site controller (CBSC), and a packet control function (PCF). As shown in FIG. 1, system 100 further comprises well-known entities like mobile switching center/virtual location register (MSC/LVR) 112, Signaling System 7 (SS7) network 114, home location register (HLR) 116, packet data serving node (PDSN) 118, internet protocol (IP) network 120, proxy Authentication, Authorization and Accounting Server (AAA) 122, and home network 124, which includes home AAA 126, Home Agent (HA) router 128, and application server 130. Although PDSN 118 is shown separate from RAN 110 in the first embodiment, it is understood that a PDSN may also be included in the RAN network equipment. In the first embodiment, a known CDMA-1X RAN is adapted using known telecommunications design and development techniques to implement the RAN aspect of the present invention. The result is RAN 110, which performs the method described with respect to FIG. 7. Those skilled in the art will recognize that the RAN aspect of the present invention may be implemented in and across various physical components of RAN 110.

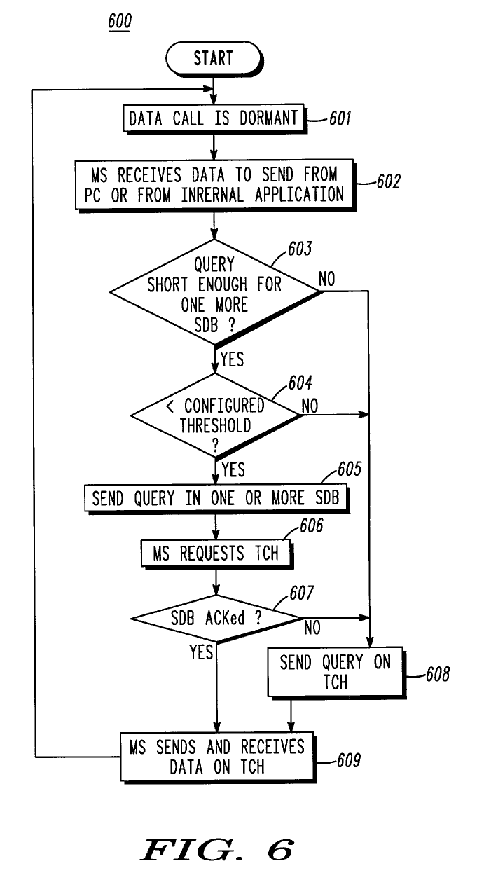

RAN 110 communicates with MS 101 via CDMA-1X air interface resources 105. MS 101 comprises a processor (e.g., memory and processing devices), a receiver, a transmitter, a keypad, and a display. Transmitters, receivers, processors, keypads, and displays as used in CDMA MSs are all well known in the art. This common set of MS components is adapted using known telecommunications design and development techniques to implement the wireless unit aspect of the present invention. Thus modified, MS 101 performs the method described with respect to FIG. 6.

Operation of the first embodiment, in accordance with the present invention, occurs substantially as follows. Under the CDMA2000 standard, after an MS enters into a dormant mode, it needs to reestablish traffic channels before transferring data to the network. The time it takes to reestablish this RF connectivity, the Wireless Network delay, varies depending on various network conditions. The theoretical estimate is about 1.2 seconds. Lab measurements are typically in the 2-5 second range, but actual performance under loaded conditions in the field may be even worse. In addition, the Data Network delay results in part from the server transport/response time. Typically, this is on the order of 1 second varying between 0.5 and 3 seconds. Under the CDMA2000 standard, the wireless user experiences these delays back-to-back when in a dormant mode. In contrast, under the present invention the wireless user experiences these delays concurrently.

Having entered a dormant mode of a data session with the fixed network, the processor of MS 101 determines that data needs to be wirelessly transferred to RAN 110. This may be data that MS 101 receives from an external source (e.g., PC 103) or data generated internally. For example, the user of MS 101 may request that a web page or file be downloaded. The data that needs to be sent would then correspond to a data query.

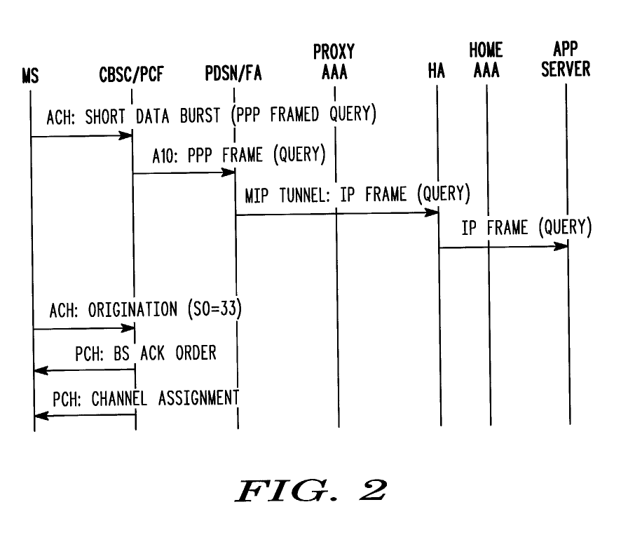

The processor of MS 101 instructs the transmitter to transmit at least a portion of the data, or data query. Using an access channel the transmitter of MS 101, transmits at least a portion of the data via a Short Data Burst (SDB) message. SDB messaging is provided under IS-707. In fact, packet data service option 33 provides for packet data uses such as this. In a second or alternate embodiment, Short Message Service (SMS) messaging may be used instead of SDB messaging. FIGS. 2-5 illustrate system messaging diagrams in accordance with the first embodiment of the present invention. The reader may refer to these diagrams for a visual depiction of the messaging discussed throughout the present discussion of the first embodiment. For example, the first message shown in FIG. 2 is the SDB just discussed with the data carried as a point-to-point protocol (PPP) framed query.

In addition to instructing the transmitter to transmit the data, the processor of MS 101 also instructs the transmitter to transmit a request for a traffic channel (TCH). In the first embodiment, this is an Origination Request Message transmitted with substantially no delay between it and the data. However, in another embodiment, both the data and the TCH request can be transmitted in a new origination message having a reduced set of the Origination Message fields (e.g., the “Dialed Digits” field would be removed) but with an optional “Query Data” field consisting of the minimal query information. In yet another embodiment, both the data and the TCH request can be transmitted in an Origination Request message that employs an extension to carry the data. Regardless whether one or two messages are transmitted, a TCH request and at least a first portion of the data to be transferred are transmitted with substantially no delay between them.

The BTS of RAN 110 receives the TCH request and the data from MS 101. The RAN network equipment of RAN 110 then forwards the received data on to its target server. Because the RAN network equipment of RAN 110 maintains an open session with PDSN 118 for all dormant MSs, when MS 101's data query is forwarded, PDSN 118 has the appropriate context information to process the query immediately. In addition to forwarding the data, RAN 110 also assigns MS 101 a TCH. The BTS of RAN 110 transmits a channel assignment to MS 101 for the TCH. The receiver of MS 101 receives the channel assignment, and MS 101 and RAN 110 proceed with the ordinary channel setup messaging.

While MS 101 and RAN 110 are setting up the TCH, the target server (e.g., application server 130) receives the data or query and can respond. The network equipment of RAN 110 will receive any query response from the target server and forward it to MS 101. If TCH setup is complete, the BTS of RAN 110 forwards the response to MS 101 via the TCH. If TCH setup is not complete, RAN 110 may buffer the response until setup is complete, or RAN 110 may forward the response (in whole or in part) via an SDB in the case where the TCH assignment has not even been transmitted yet. Thus, the receiver of MS 101 receives a response to the data query either via the TCH, after it is established, or via an SDB.

Once the TCH is established (i.e., MS 101's data session becomes active), MS 101 and RAN 110 can use the TCH for further data transfer. For example, MS 101 may need to send the rest of the data that initially triggered the origination request, or perhaps new data is exchanged. A user browsing the Internet, for example, may generate subsequent queries or targeted servers may query the user. MS 101 and RAN 110 use the TCH to transfer data until an inactivity timer expires and MS 101 returns to a dormant mode.

Thus, the first embodiment of the present invention improves a wireless user's perception of network response time by overlapping the Wireless Network delay with the Data Network delay. A dormant user necessarily experiences the sum of these two delays today when accessing the packet network. By providing the means for transmitting a data query, for example, at the same time as requesting a channel, the first embodiment of the present invention reduces the total data transfer delay.

FIG. 6 is a logic flow diagram of steps executed by a wireless unit in accordance with a first embodiment of the present invention. Logic flow 600 begins when a wireless unit (e.g., an MS) in a dormant state (601) determines (602) that data (e.g., a data query) needs to be sent via the RAN presently serving the MS. The MS determines (603) whether the query is short enough for one or more SDBs, and specifically, (604) whether the query is less than or equal to a pre-configured threshold (i.e., a maximum size). If so, the data is sent (605) via SDB(s) and a traffic channel is requested (606). If the data is longer than the pre-configured threshold, then the data is not sent until the TCH has been established (608). In the case where an SDB is transmitted but not acknowledged (607) by the time a channel assignment is received for the TCH, data that was sent via SDB is retransmitted. With the TCH established, the now active (i.e., no longer dormant) MS can send and receive data (609) via the TCH until reentering a dormant state (601) due to inactivity.

FIG. 7 is a logic flow diagram of steps executed by a RAN in accordance with a first embodiment of the present invention. Logic flow 700 begins when the RAN receives (701) messaging from a dormant MS via an access channel. The RAN determines (702) whether the messaging is an origination request or an SDB. If an SDB, the RAN forwards (703) the data conveyed by the SDB to a PDSN for routing to the targeted server. Then upon receiving (704) an origination message from the MS, the RAN proceeds (705) with TCH setup. After receiving (706) data for the MS, the RAN determines (707) whether a channel assignment has been transmitted for the MS yet. If not, the RAN can either (708) store the data until a TCH is setup or transmit some or all the data via SDB(s). Once the TCH is setup, the RAN and the MS can actively exchange (709) data as needed via the TCH. Logic flow 700 then repeats after the MS falls dormant and the TCH is de-assigned.

While the present invention has been particularly shown and described with reference to particular embodiments thereof, it will be understood by those skilled in the art that various changes in form and details may be made therein without departing from the spirit and scope of the present invention.

What is claimed is:

1. A method for a wireless unit to reduce wireless data transfer delay comprising:
entering a dormant mode of a data session;
determining that data needs to be wirelessly transferred;
transmitting at least a portion of the data via an access channel;
transmitting a request for a traffic channel, wherein substantially no delay is introduced between transmitting the first portion of the data and transmitting the request; and
receiving a channel assignment for a traffic channel.

2. The method of claim 1 further comprising transmitting any remaining portion of the data via the traffic channel.

3. The method of claim 1 wherein the data comprises a data query.

4. The method of claim 3 further comprising receiving data in response to the data query via the traffic channel.

5. The method of claim 3 wherein the data query comprises a point-to-point (PPP) framed query.

6. The method of claim 3 wherein transmitting the at least a portion of the data comprises determining that the data query is less than or equal to a maximum size.

7. The method of claim 1 wherein transmitting at least a portion of the data via an access channel comprises transmitting at least a portion of the data via a Short Data Burst (SDB) message.

8. The method of claim 1 wherein transmitting at least a portion of the data via an access channel comprises transmitting at least a portion of the data via a Short Message Service (SMS) message.

9. The method of claim 1 wherein transmitting the request for a traffic channel comprises transmitting an Origination Request message.

10. The method of claim 1 wherein the at least a portion of the data and the request for a traffic channel are transmitted together in a single message.

11. The method of claim 10 wherein the single message is an Origination Request message with an extension for the at least a portion of the data.

12. The method of claim 1 wherein the channel assignment for the traffic channel is received before any acknowledgment of the at least a portion of the data that was transmitted and wherein the method of claim A further comprises retransmitting the at least a portion of the data via the traffic channel.

13. A method for a radio access network to reduce wireless data transfer delay comprising:
receiving data via an access channel from a wireless unit whose data session is dormant;
receiving a request for a traffic channel from the wireless unit, wherein substantially no delay occurs between receiving the data and receiving the request;
forwarding the data to a target server; and
transmitting a channel assignment for a traffic channel to the wireless unit.

14. The method of claim 13 further comprising receiving subsequent data from the wireless unit via the traffic channel.

15. The method of claim 13 wherein receiving data via the access channel comprises receiving the data via a Short Data Burst (SDB) message.

16. The method of claim 13 wherein the data received via the access channel comprises a data query.

17. The method of claim 16 further comprising receiving query response data from the target server and forwarding the query response data to the wireless unit.

18. The method of claim 17 wherein the query response data is forwarded to the wireless unit via the traffic channel.

19. The method of claim 18 wherein the query response data is buffered by the radio access network until traffic channel setup is complete.

20. The method of claim 17 wherein the query response data is forwarded to the wireless unit via a Short Data Burst (SDB) message if the channel assignment has not been transmitted.

21. A wireless unit comprising:
a transmitter;
a receiver adapted to receive a channel assignment for a traffic channel; and
a processor, coupled to the transmitter and the receiver, adapted to enter a dormant mode of a data session, adapted to determine that data needs to be wirelessly transferred, and adapted to instruct the transmitter to transmit at least a portion of the data via an access channel and a request for a traffic channel, wherein substantially no delay is introduced between transmitting the first portion of the data and transmitting the request.

22. A radio access network (RAN) comprising:
a base transceiver station adapted to receive data via an access channel from a wireless unit whose data session is dormant, adapted to receive a request for a traffic channel from the wireless unit, wherein substantially no delay occurs between receiving the data and receiving the request, and adapted to transmit a channel assignment for a traffic channel to the wireless unit; and
RAN network equipment, coupled to the base transceiver station, adapted to forward the data to a target server.

23. The RAN of claim 22 wherein the RAN network equipment comprises a base site controller (BSC) and a packet control function (PCF).

24. The RAN of claim 23 wherein the RAN network equipment further comprises a packet data serving node (PDSN).
